(19) United States
(12) Patent Application Publication
(10) Pub. No.: US 2019/0002736 A1
(43) Pub. Date: Jan. 3, 2019

(54) ADHESIVE ARTICLE LINER WITH SORBENT MATERIAL

(71) Applicant: 3M INNOVATIVE PROPERTIES COMPANY, St. Paul, MN (US)

(72) Inventors: Kiu-Yuen Tse, Woodbury, MN (US); Shijing Cheng, Woodbury, MN (US); David J. Yarusso, Shoreview, MN (US)

(73) Assignee: 3M INNOVATIVE PROPERTIES COMPANY, Saint Paul, MN (US)

(21) Appl. No.: 16/062,931

(22) PCT Filed: Dec. 13, 2016
(86) PCT No.: PCT/US2016/066256

§ 371 Date: Jun. 15, 2018

Related U.S. Application Data
(60) Provisional application No. 62/269,687, filed on Dec. 18, 2015.

(51) Int. Cl. C09J 7/21; C09J 7/38; C09J 7/20; C09J 7/40; C09J 11/04; B01J 20/20; B01J 20/28; D06N 3/00; D06N 3/12

(52) U.S. Cl. CPC C09J 7/21; D06N 2209/1664; C09J 7/201; C09J 7/401; C09J 7/405; C09J 11/04; B01J 20/20; B01J 20/28028; D06N 3/0011; D06N 3/0059; D06N 3/0088; D06N 3/128; D06N 3/0084; C09J 2205/106; C09J 2400/10; C09J 2483/005; C09J 2467/006; C09J 2423/106; C09J 2401/006; C09J 2433/00; D06N 2201/0254; D06N 2201/042; D06N 2209/165; C09J 7/385

(57) ABSTRACT

Described herein is a liner comprising a sorbent material entrapped in a non-woven fiber matrix, wherein the liner comprises a first and a second major surface; and a first adhesive layer contacting the first major surface of the liner, wherein the first adhesive layer comprises a pressure sensitive adhesive.

### TECHNICAL FIELD

Liners for adhesive articles are disclosed wherein the liner comprises a sorbent material to sorb volatile organic compounds from pressure sensitive adhesives.

### DESCRIPTION OF THE FIGURE

FIG. 1 is a cross-sectional view of an adhesive article according to one embodiment of the present disclosure.

### SUMMARY

There is a desire to provide an adhesive article comprising a material to sorb volatile organic compounds in an economical fashion.

In one aspect, an article is described comprising:

a support having a first and a second major surface, the support comprising an absorbent material entrapped in a non-woven fiber matrix, wherein the support comprises a first and a second major surface and wherein the absorbent material is present in no more than 50% by weight of the support; and a release coating layer on at least the first major surface of the support.

In another aspect, a method of making an adhesive article comprising:

(a) providing a support comprising an absorbent material entrapped in a non-woven fiber matrix and wherein the absorbent material is present in no more than 50% by weight of the support;
(b) disposing a release coating layer onto the support to form a liner; and
(c) disposing a pressure sensitive adhesive layer onto the liner such that the pressure sensitive adhesive layer is in contact with the release coating layer.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term

“a”, “an”, and “the” are used interchangeably and mean one or more; and

“and/or” is used to indicate one or both stated cases may occur, for example A and/or B includes, (A and B) and (A or B).

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

Volatile organic compounds (VOCs) are any compounds comprising carbon (excluding carbon monoxide, carbon dioxide, carbonic acid, metallic carbides or metallic carbonates, and ammonium carbonate) that have sufficient vapor pressures such that under normal conditions, vaporize, and enter the atmosphere. It can be advantageous to contain VOCs in finished goods, such as adhesive articles, to (a) limit VOC release into the environment, which can be environmentally or odorously undesirable, and/or (b) prevent the VOC from impacting the performance or aesthetics of the finished good.

U.S. Pat. Publ. No. 2013/0183471 (Luhmann et al.) discloses a liner for the protection of adhesives, comprising at least one adhesive release layer and at least one layer of a getter material capable of sorbing permeable substances. The getter material layer is formed substantially by the getter material, preferably made of pure getter material.

It has been discovered that by placing a sorbent material into the liner of an adhesive article, capture of VOCs can be achieved.

VOCs as disclosed herein include permeable substances which migrate through the adhesive article and either (a) impact the performance or aesthetics of the adhesive article and/or (b) outgas from the adhesive article causing odor, fogging, and/or environmental concerns. The permeable substances can include volatile and semi-volatile organic compounds. Typically volatile compounds would comprise those compounds having up to 20 carbon atoms, whereas the semi-volatile compounds would comprise those compounds having 16 to 32 carbon atoms. The VOCs of interest to capture in the present disclosure are solvents and raw materials used in manufacture, contaminates in the raw materials, and/or by-products from the manufacture. Exemplary VOCs include, acetonitrile, 1-butanol, chlorobenzene, chloroform(trichloromethane), cyclohexane, diethyl ether, 1,4-dioxane, glacial acetic acid(acetic acid), acetic anhydride, acetic acid ethyl ester(ethyl acetate, ethyl ethanoate), acetic acid n-butyl ester(n-butyl acetate), acetic acid tert-butyl ester(tert-butyl acetate), ethanol, methanol, n-hexane, n-heptane, 3-hexanone, 2-propanol(isopropanol), 3-methyl-1-butanol(isoamyl alcohol), methylene chloride(dichloromethane), 2-ethyl hexyl acrylate, 2-ethyl hexyl alcohol, 2-ethyl hexyl acetate, methyl ethyl ketone(butanone), methyl isobutyl ketone, nitromethane(nitrocarbol), n-pentane, 2-pentanone, 3-pentanone, petroleum ether(light benzine), benzine, propanol, pyridine(azine), ten-butyl methyl ether, tetrachloroethene(perchloroethene), tetrahydrofuran, toluene, trichloroethane, triethylamine, xylene, methane, ethane, propane, propene, butane, and butene.

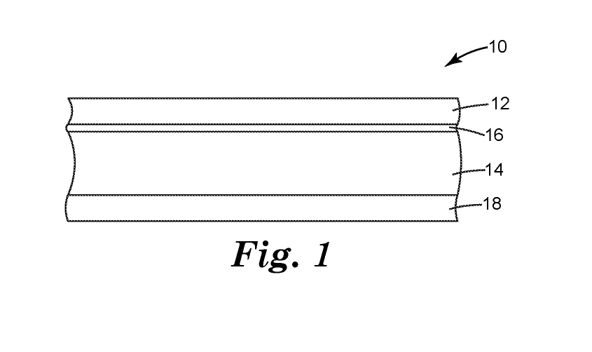

The present application is directed toward a liner for an adhesive article. As used herein, a backing is a permanent support intended for final use of the adhesive article. A liner, on the other hand, is a temporary support that is not intended for final use of the adhesive article and is used during the manufacture or storage to support and/or protect the adhesive article. A liner is removed from the adhesive article prior to use. Advantages of the use of a liner for VOC removal is that the liner can be used to sorb the VOC from the adhesive article and then be removed from article, thereby removing the VOC and/or the liner can be reused. For illustrative purposes, shown in FIG. 1 is one exemplary embodiment of an adhesive article according to the present disclosure. Adhesive article 10 comprises a liner, which comprises support 12 with release coating layer 16 disposed thereon; and adhesive layer 14. The adhesive article may optionally comprise backing 18 in contact with adhesive layer 14, opposite the liner.

Liner

The liner of the present disclosure comprises a support comprising a sorbent material entrapped in a non-woven fiber matrix, which is coated with a release coating layer. In one embodiment, the support may comprise a polyolefin layer disposed between the non-woven fiber matrix and the release coating, which is known in the art. The polyolefin layer is a low density polyolefin (such as polyethylene, polypropylene or combinations thereof).

The support of the present disclosure is made of non-woven material such as spunbond non-woven, melt blown non-woven, carded web, airlaid non-woven, needlepunched non-woven, spunlace non-woven, suitable combinations of the above and the like. The non-woven fiber matrix can be made from natural fiber and/or synthetic polymer fiber.

Exemplary synthetic polymer fiber include polyethylene, polypropylene, polyester, nylon, polylactic acid, and combinations thereof.

Exemplary natural fiber include cellulose, hemp, bamboo, cotton, and combinations thereof.

To ensure adequate support and structural integrity of the support, at least some of the fibers may comprise an adequate length and diameter. For example, a length of at least 2 mm, 3 mm, 4 mm, 6 mm, 8 mm, 10 mm, 15 mm, 20 mm, 25 mm, or even 30 mm, and a diameter of at least 10 μm (micrometer), 20 μm, 40 μm, or even 60 μm.

In one embodiment, to entrap the sorbent particles and/or ensure a high surface area material, the fibers may comprise a main fibers surrounded by many smaller attached fibrils. The main fiber generally can have a length in the range of 0.8 mm to 4 mm, and an average diameter between 1 to 20 micrometers. The fibrils typically have a submicrometer diameter.

In one embodiment, two or more different kinds of fibers may be used to enhance the performance of the support.

The support of the present disclosure comprises a sorbent material capable of sorbing the VOCs. The sorbing of the VOCs by the sorbing material occurs via absorption and/or adsorption. Adsorption may occur in the form of chemisorption and/or physisorption.

In one embodiment, the sorbent material is porous. The porous nature will enable, for example, more surface area for VOC removal. Preferably, the sorbent material has a high surface area (e.g., at least 100, 200, 500, 600 or even 700 m²/g; and at most 1000, 1200, 1400, 1500, or even 1800 m²/g based on BET (Brunauer Emmet Teller method) nitrogen adsorption).

The sorbent material may be microporous (having pore widths smaller than 2 nanometers), macroporous (having pore widths between 2 and 50 nanometers), mesoporous (having pore widths larger than 50 nm), or a mixture thereof.

In one embodiment, the sorbent material is predominately microporous, meaning that 65, 75, 80, 85, 90, 95, or even 99% of the pores are microporous, however some of the pores may be larger than microporous.

The sorbent materials of the present disclosure are those materials that have high surface area to volume ratios. Exemplary sorbent material include activated carbon, carbon nanotubes, silica gel, and a zeolite.

Activated carbon, is carbon that has been processed to make it highly porous (i.e., having a large number of pores per unit volume), which thus, imparts a high surface area. Activated carbons may be generated from a variety of materials, however most commercially available activated carbons are made from peat, coal, lignite, wood, and coconut shells. Based on the source, the carbon can have different pore sizes, ash content, surface order, and/or impurity profiles. Coconut shell-based carbon has predominantly a microporus pore size, whereas a wood-based activated carbon has a predominately mesoporous or macroporous pore size. Coconut shell- and wood-based carbon typically have ash contents less than about 3% by weight, whereas coal-based carbons typically have ash contents of 4-10% by weight or even higher.

Commercially available activated carbons include: activated wood-based carbon available under the trade designation “NUCHAR RGC”, by Mead Westvaco Corp, Richmond, Va.; wood-based carbon available under the trade designation “AQUAGUARD” by Mead Westvaco Corp; activated coconut shell-based carbon available under the trade designation “KURARAY PGW” by Kuraray Chemical Co., LTD, Okayama, Japan; and coal-based carbon available under the trade designations “CARBSORB” and “FILTRASORB” by Calgon Carbon Corp., Pittsburgh, Pa.

Silica gel is a vitreous, porous form of silicon dioxide that is hydroscopic and commonly used as a desiccant. Typically silica gel is made from the acidification of sodium silicate solutions, which is then washed and dehydrated to form a microporous silica.

Zeolites are porous aluminosilicate minerals, which are highly crystalline. Zeolites can occur naturally or be produced synthetically. A commercially available zeolite includes ZEOFLAIR a microporous, organophilic inorganic powder available from Zeochem AG, Karst, Germany.

In one embodiment, the sorbent material is distributed throughout the support layer. In one embodiment, the sorbent material is distributed substantially uniformly through a cross-section of the support, meaning that the sorbent material is present at roughly the same concentration (e.g., within 10%) throughout the cross-section of the support.

In one embodiment, the sorbent material is present in no more than 50%, 40%, 30%, or even 20% or less by weight per weight of the support; and at least 5% or even 10% by weight per weight of the support.

In one embodiment, the thickness of the support is at least 50, 75, 100, 125, or even 150 microns. In one embodiment, the thickness of the support is no more than 1 mm, 800 microns, 500 microns, or even 300 microns.

In one embodiment, a porous fiber matrix is used to entrap the sorbent material. For example, the fibers are mixed to form a pulp and the sorbent material is added. Then a polymeric binder is added to bind the fibrous pulp together and the liquid is removed to form the support.

Useful binders are those materials that are stable and that exhibit little or no interaction (i.e., chemical reaction) with either the fibers of the pulp or the sorbent material entrapped therein. Natural and synthetic polymeric materials, originally in the form of latexes, may be used. Common examples of useful binders include, but are not limited to, natural rubbers, neoprene, styrene-butadiene copolymer, acrylate resins, polyvinyl chloride, and polyvinyl acetate. In one embodiment, the backing layer comprises less than 25%, 20%, 15%, 10%, 5%, 3%, or even less than 1% based on weight of the binder versus total weight of the backing layer.

In one embodiment, the support further comprises colorants (such as titanium dioxide), antioxidants, and other additives known in the art.

The basis weight of the support will vary widely depending upon the particular application, but normally will be in the range from about 20 grams per square meter to 75 grams per square meter or even in the range from about 20 grams per square meter to 60 grams per square meter, although heavier or lighter support can be use if desired.

In one embodiment, the support of the present disclosure has a surface area of at least 10, 50, 100, 150, or even 200 m²/g based on MBET (modified Brunauer Emmet Teller method) nitrogen adsorption).

In one embodiment, the support of the present disclosure has a calculated average pore diameter per ISO 15901-3:2007 of more than 1.0 nm and no more than 10, 5 or even 3.0 nm.

To facilitate easy removal from the adhesive layer, the liner comprises a release coating layer disposed onto the support. The release coating layer comprises a release agent. Such release agents are known in the art and are described, for example in “Handbook of Pressure Sensitive Adhesive Technology,” D. Satas, editor, Van Nostrand Reinhold, New York, N.Y., 1989, pp. 585-600. In one embodiment, the release agent migrates to the surface (on the liner or release coating) to provide the appropriate release properties.

Examples of release agents include carbamates, urethanes, silicones, fluorocarbons, fluorosilicones, and combinations thereof. Carbamate release agents generally have long side chains and relatively high softening points. An exemplary carbamate release agent is polyvinyl octadecyl carbamate, available from Anderson Development Co. of Adrian, Mich., marketed as ESCOAT P20, and from Mayzo Inc. of Norcross, Ga., marketed in various grades as RA-95H, RA-95HS, RA-155 and RA-585S.

Illustrative examples of surface applied (i.e., topical) release agents include polyvinyl carbamates such as disclosed in U.S. Pat. No. 2,532,011 (Dahlquist et al.), reactive silicones, fluorochemical polymers, epoxysilicones such as are disclosed in U.S. Pat. No. 4,313,988 (Bany et al.) and U.S. Pat. No. 4,482,687 (Kessel et al.), polyorganosiloxane-polyurea block copolymers such as are disclosed in European Appl. No. 250,248 (Leir et al.), etc.

Silicone release agents generally comprise an organopolysiloxane polymer comprising at least two crosslinkable reactive groups, e.g., two ethylenically-unsaturated organic groups. In some embodiments, the silicone polymer comprises two terminal crosslinkable groups, e.g., two terminal ethylenically-unsaturated groups. In some embodiments, the silicone polymer comprises pendant functional groups, e.g., pendant ethylenically-unsaturated organic groups. In some embodiments, the silicone polymer has a vinyl equivalent weight of no greater than 20,000 grams per equivalent, e.g., no greater than 15,000, or even no greater than 10,000 grams per equivalent. In some embodiments, the silicone polymer has a vinyl equivalent weight of at least 250 grams per equivalent, e.g., at least 500, or even at least 1000 grams per equivalent. In some embodiments, the silicone polymer has a vinyl equivalent weight of 500 to 5000 grams per equivalent, e.g., 750 to 4000 grams per equivalent, or even 1000 to 3000 grams per equivalent.

Commercially available silicone polymers include those available under the trade designations “DMS-V” from Gelest Inc., e.g., DMS-V05, DMS-V21, DMS-V22, DMS-V25, DMS-V31, and DMS-V33. Other commercially available silicone polymers comprising an average of at least two ethylenically-unsaturated organic groups include “SYL-OFF 2-7170” and “SYL-OFF 7850” (available from Dow Corning Corporation), “VMS-T11” and “SIT7900” (available from Gelest Inc.), “SILMER VIN 70”, “SILMER VIN 100” and “SILMER VIN 200” (available from Siltech Corporation), and 2,4,6,8-tetramethyl-2,4,6,8-tetravinylcyclotetrasiloxane (available from Aldrich).

The release agent may also comprise a fluorosilicone polymer. Commercially available ethylenically unsaturated fluorosilicone polymers are available from Dow Corning Corp, (Midland, Mich.) under the SYL-OFF series of trade designations including, e.g., “SYL-OFF FOPS-7785” and “SYL-OFF FOPS-7786”. Other ethylenically unsaturated fluorosilicone polymers are commercially available from General Electric Co. (Albany, N.Y.), and Wacker Chemie (Germany). Additional useful ethylenically unsaturated fluorosilicone polymers are described as component (e) at column 5, line 67 through column 7, line 27 of U.S. Pat. No. 5,082,706 (Tangney). Fluorosilicone polymers are particularly useful in forming release coating compositions when combined with a suitable crosslinking agent. One useful crosslinking agent is available under the trade designation “SYL-OFF Q2-7560” from Dow Corning Corp. Other useful crosslinking agents are disclosed in U.S. Pat. No. 5,082,706 (Tangney) and U.S. Pat. No. 5,578,381 (Hamada et al.).

The release coating is applied to the support to form the liner. Such coating techniques are known in the art and including but not limited to, dip coating, roll coating, spray coating, knife coating, gravure coating, extrusion, die-coating, and the like. In one embodiment, the support is treated (e.g., corona treated) before application of the release coating to improve bonding between the support and the release coating layer.

In one embodiment, the thickness of the release coating is at least 0.1, 0.5, or even 1 micrometer and no more than 4, 10, 25, or even 50 micrometers.

Adhesive Layer

An adhesive layer substantially coats the release coating layer of the liner. In the present disclosure, the adhesive layer is a pressure-sensitive adhesive (PSA) PSAs are adhesives whose set film in the dry state at room temperature remains permanently tacky and adhesive. Even with relatively weak applied pressure, PSAs permit a durable bond to be made to the substrate, and after use can be detached from the substrate again with substantially no residue. The bondability of the adhesives is based on their adhesive properties and their redetachability on their cohesive properties.

The PSAs used in the present disclosure include those known in the art. The pressure-sensitive adhesive can include a solvent-based pressure-sensitive adhesive and/or a water-based pressure-sensitive adhesive, a hot melt coated pressure sensitive adhesive or an adhesive formed by polymerization on a substrate. The pressure-sensitive adhesive can include at least one of an acrylic, a tackified acrylic, a vinyl ether, a tackified rubber-based adhesive (wherein the rubber is for example: natural rubber, styrene-isoprene copolymers, an acrylonitrile-butadiene copolymer, styrene-butadiene copolymer, acrylic polymer), silicone, polyurethanes, polyesters, and vinyl ethers.

In some embodiments tackifiers and plasticizers may also be added to the adhesive composition that makes up the adhesive layer. Tackifiers, include for example, rosin, rosin derivatives, hydrogenated rosin derivatives, polyterpene resins, phenolic resins, coumarone-indene resins, poly-t-butyl styrene and combinations thereof. Plasticizers include for example, hydrocarbon oils, hydrocarbon resins, polyterpenes, rosin esters, phthalates, phosphate esters, dibasic acid esters, fatty acid esters, polyethers, and combinations thereof.

In one embodiment, the adhesive compositions may be coated onto the liner by any of a variety of conventional coating techniques known in the art, such as roll coating, spray coating, knife coating, extrusion, die-coating, and the like.

In one embodiment, the adhesive layer thickness typically may be in the range of about 0.0025 mm to 0.13 mm (0.1 mil to 5.0 mil), and more typically in the range of about 0.0013 mm to 0.076 mm (0.5 mil to 3.0 mil).

In addition to the liner and adhesive layer, the adhesive articles of the present disclosure may further comprise a backing (or permanent support). Such backings are known in the art. Alternatively, the adhesive articles of the present disclosure may not comprise a backing or comprise an adhesive layer of both sides of a backing with a liner is used on one or both sides of the exposed adhesive layer. These adhesive articles of the present disclosure may include a tape and/or a label.

It has been discovered that a liner comprising a sorbent material can be used to effectively sorb VOC. For example, in one embodiment, the adhesive article of the present disclosure has a VOC of less than 1000, 500, or even 100 as measured by the German Automotive Industry Association (Verband der Automobilindustrie (VDA)) test method VDA 278 (2011): “Thermal Desorption Analysis of Organic Emissions for the Characterization of Non-Metallic Materials for Automobiles” and/or the VOC Test Method disclosed herein. In one embodiment, the adhesive article of the present disclosure has an adhesive article has a FOG of less than 100, 50, 10, or even 5 as measured by as measured by VOC Test Method disclosed herein.

By incorporation of the sorbing material into the support layer, less process steps are needed and/or less sorbing material can be used.

The liner should be of a sufficient construction, such that it peels relatively easily away from the adhesive with little adhesive residue present on the liner; and it can optionally be reused. In one embodiment the liner of the present disclosure has an average release force of less than 1, 2, 5, 10, 25, 50, or even 100 g/in; and at most 250, 500, or even 1000 g/in via the Release Force Test disclosed herein.

Exemplary embodiments of the present disclosure include, but are not limited to the following:

### Embodiment 1

An article comprising:

a support having a first and a second major surface, the support comprising an absorbent material entrapped in a non-woven fiber matrix, wherein the support comprises a first and a second major surface and wherein the absorbent material is present in no more than 50% by weight of the support;

a release coating layer on at least the first major surface of the support.

### Embodiment 2

The article of embodiment 1, further comprising a first adhesive layer contacting the release coating layer, wherein the first adhesive layer comprises a pressure sensitive adhesive.

### Embodiment 3

The article of embodiment 2, wherein the release coating layer comprises a silicone.

### Embodiment 4

The article of any one of the previous embodiments, wherein the absorbent material is a porous material.

### Embodiment 5

The article of any one of the previous embodiments, wherein the absorbent material comprises at least one of an activated carbon, a silica gel, a zeolite, and mixtures thereof.

### Embodiment 6

The article of any one of the previous embodiments, wherein the non-woven fiber matrix comprises fibers, wherein the fibers comprises at least one of a natural fiber, a synthetic polymer fiber, and mixtures thereof.

### Embodiment 7

The article of embodiment 6, wherein the synthetic polymer fiber comprises at least one of polyethylene, polypropylene, polyester, nylon, polylactic acid, and combinations thereof.

### Embodiment 8

The article of embodiment 6, wherein the natural fiber comprises at least one of cellulose, hemp, bamboo, cotton, and mixtures thereof.

### Embodiment 9

The article of any one of the previous embodiments, further comprising a first pressure sensitive adhesive, wherein the first pressure sensitive adhesive is disposed on the release coating layer.

### Embodiment 10

The article of embodiment 9, wherein the first pressure sensitive adhesive comprises at least one an acrylic, a tackified acrylic, a tackified rubber-based adhesive, silicone, polyurthanes, and combinations thereof.

### Embodiment 11

The article of any one of the previous embodiments, further comprising a second release coating layer on the second major surface of the support.

### Embodiment 12

The article of any one of embodiments 8-11, further comprising a second pressure sensitive adhesive disposed on the second major surface of the support.

### Embodiment 13

The adhesive article of embodiment 12, wherein the second pressure sensitive adhesive is different from the first pressure sensitive adhesive.

### Embodiment 14

The adhesive article of embodiment 12, wherein the second pressure sensitive adhesive is the same as the first pressure sensitive adhesive.

### Embodiment 15

The article of any one of the previous embodiments, wherein the article is a tape.

### Embodiment 16

The article according to any one of the previous embodiments, wherein the article has a VOC of less than 1500 μg/g as measured by VOC Test Method.

### Embodiment 17

The article according to any one of the previous embodiments, wherein the article has a FOG of less than 200 μg/g as measured by VOC Test Method.

### Embodiment 18

A method of making an adhesive article having low volatiles comprising:

(a) providing a support comprising an absorbent material entrapped in a non-woven fiber matrix and wherein the absorbent material is present in no more than 50% by weight of the support;
(b) disposing a release coating layer onto the support to form a liner; and
(c) disposing a pressure sensitive adhesive layer onto the liner such that the pressure sensitive adhesive layer is in contact with the release coating layer.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Mo., or may be synthesized by conventional methods.

These abbreviations are used in the following examples: g=grams, min=minutes, and hr=hour.

### Materials

| Component | Description |
|---|---|
| Support 1 | Engineered carbon sheet available from MeadWestVaco, Covington, VA. The sample |
| | comprises 5-95% cellulose fiber and <5% polyester solid with a 5-75% by wt loading |
| | of activated carbon, 25-95% by wt of fiber. Measured basis weight is 61.2 g/m² with a |
| | thickness of 0.743 mm. |
| Support 2 | Engineered carbon sheet available from MeadWestVaco. The sample comprises |
| | polypropylene fiber with a 40-48% by wt loading of activated carbon, 32-37% by wt of |
| | fiber and 8-12% by wt of binder. Measured basis weight is 128.0 g/m² with a thickness |
| | of 0.874 mm. |
| Primed PET | Primed PET (HOSTAPHAN 3SAB primed polyester film available from Mitsubishi |
| | Polyester Film Inc, Greer, S.C. |
| Siloxane | Linear vinyl-terminated PDMS base polymer available under the trade designation of |
| Polymer | SYL-OFF 2-7170 from Dow Corning Corporation, Midland, MI. |
| Siloxane | Trimethylsiloxy-terminated methylhydrogen siloxane, 100% active solids silicone |
| Crosslinker | crosslinker, available under the trade designation of SYL-OFF 7048 Crosslinker, |
| | available from Dow Corning Corporation, Midland, MI. |

Volatile Organic Compound Emissions and FOG Testing (VOC Test Method)

Analysis of volatile organic emissions and FOG properties was done according to the German Automotive Industry Association (Verband der Automobilindustrie (VDA)) test method VDA 278 (2011): “Thermal Desorption Analysis of Organic Emissions for the Characterization of Non-Metallic Materials for Automobiles” using Markes Unity Thermal Desorption/Agilent 6890/5975 GC/MS instrumentation. Toluene and hexadecane are used as surrogate standards for VOC and FOG measurements respectively. The samples were not evaluated seven days after the initial test. The samples mass was calculated as per mass of adhesive layer without the mass of the Backing.

Laminate articles were prepared by applying silicone release coated supports to the exposed adhesive of an adhesive transfer tape as described in the Examples below. These laminate articles were wrapped in aluminum foil and stored at room temperature until use. The laminate articles were all prepared on the same day and stored 18 days before testing.

Samples were prepared for testing by removing the Kraft paper liner from the laminate article and laminating the exposed adhesive surface to one side of a 0.002 inch (50 micrometer) thick, untreated polyester film using a rubber roller and hand pressure. Next, a sample measuring 2 millimeters wide and having a length of between 2 and 3 centimeters was cut to fit inside the mid-section of the 0.25 inch diameter glass tubes used in the thermal desorption system and the silicone release coated Sorbent Non-Woven Sheet was removed. The resulting samples pieces were then evaluated as described in VDA 278 to measure volatile organic compound (VOC) emissions and FOG properties. The polyester film by itself was also evaluated as a blank and the result was subtracted from the raw sample before the calculations are completed. Two samples were run for each laminate article and the higher value was reported.

Release Force Test Method

The release force between the silicone release coated support and adhesive was measured on a laminate article having a width of 1 inch (2.54 cm) and a minimum length of 5 inches (12.7 cm) using an IMASS Model SP2000 Slip/Peel Tester (available from IMASS, Incorporated, Accord, MA) at angle of 180 degrees and a rate of 12 inches/minute (30.5 cm/minute). The samples were prepared by applying the 9576 transfer adhesive to one side of a 0.002 inch (50 micrometer) thick, primed PET film using a rubber roller and then removing the Kraft paper liner. Then, the exposed adhesive surface was laminated with silicone release coated sorbent non-woven sheet. The samples were then wrapped in aluminum foil and stored at room temperature for days as specified until tested. For Examples 1-2, the laminate articles were all prepared on the same day and stored 3 days before testing.

While testing, the PET film was oversized and was taped at its' edges to the metal platen of the peel tester. The silicone release coated sorbent non-woven sheet was peeled off and the release force was measured. Two samples were run and the average value reported in Newtons/centimeter.

Gas Sorption Test for Surface Area and Pore Size

The test was conducted on Autosorb IQ gas sorption analyzer from Quantachrome Instruments, FL. N₂ was used as the adsorbate to obtain isotherm (sorbed gas volume vs. partial pressure P/P₀ in the range of 10̂-5˜0.995) at 77K. Surface area was calculated with multiple points in the selected partial pressure range based on Brunauer-Emmett-Teller (BET) theory, and average pore size was calculated based on the information of surface area and the last point in the adsorption range (P/P₀˜0.995) for micropore and mesopore size range (diameter up to ˜50 nm). The results are reported in Table 1 below.

TABLE 1

| | Surface area | Average Pore diameter/ |
|---|---|---|
| Backing No. | MBET/(m2/g) | (nm) |
| 1 | 630.8 | 3.1 |
| 2 | 466.7 | 3.6 |

Preparation of Silicone Release Coated Support

The designated support was coated with a composition containing a Siloxane Crosslinker and a Siloxane Polymer and having a hydride/vinyl ratio of approximately 1.8. The dark side of support sheet was first corona treated in air (Corona Dose 0.1 milliJoules/square centimeter), then coated with the composition using a four-roll coater and dried in a 305 centimeter (10 feet) long oven at a line speed of 15.2 meters/minute (50 feet/minute). The oven temperature was set at 132° C. (270° F.). The coating weight was 1.55 grams/square meter measured using a benchtop X-ray fluorescent (XRF) analyzer (model Lab X-3000, from Oxford Instruments plc, Oxfordshire, UK). The silicone release coated Sorbent Non-Woven Sheet was then stored in a desiccator for at least one day before using.

Adhesive Transfer Tape 1

Adhesive Transfer Tape 1 is a 0.004 inch (0.10 mm) thick acrylic adhesive tape on a 0.004 inch (0.10 mm) thick, densified kraft paper liner. The adhesive transfer tape has the following construction: adhesive/kraft paper liner.

Adhesive Transfer Tape/Sorbent Liner Laminate

The designated support coated with the silicone release agent was laminated to the exposed adhesive surface of Adhesive Transfer Tape 1 with the silicone release side of the liner contacting the adhesive. The laminate construction was pressed together using a rubber roller and hand pressure creating the following construction: Support/release coating/adhesive/kraft paper liner.

### Examples 1-2

Various Adhesive Transfer Tape/Sorbent Liner Laminates were prepared and evaluated for VOC, FOG, and Release Force using the test methods described above. The support used and the test results are shown in Table 2 below.

### Comparative Example 1 (CE 1)

A 0.002 inch (50 micrometer) thick, untreated polyethylene terephthalate (PET) film was laminated as described in Adhesive Transfer Tape/Sorbent Backing Laminate creating the following construction: PET/adhesive/kraft paper liner. The kraft paper liner was removed and the sample was tested per the VOC Test Method except that instead of a blank glass tube used as the blank, the PET film without the adhesive was run under the same conditions and this result was subtracted from the raw sample peak area of the PET/adhesive sample before the calculations were completed to determine the VOC and FOG levels of the adhesive itself. The result is reported in Table 2.

TABLE 2

| | | | | Average | |
|---|---|---|---|---|---|
| Exam- | Backing | VOC | FOG | Release | |
| ple | No. | μg/g | μg/g | Force (N/cm) | Release Mode |
| 1 | 1 | <23 | <4 | 219.5 | 60% clean, 40% split |
| 2 | 2 | 462 | 6 | 350.9 | 10% split, 90% light |
| | | | | | residue on PSA |
| CE1 | none | 3952 | 244 | not applicable | not applicable |

Foreseeable modifications and alterations of this invention will be apparent to those skilled in the art without departing from the scope and spirit of this invention. This invention should not be restricted to the embodiments that are set forth in this application for illustrative purposes.

1. An article comprising:
a support having a first and a second major surface, the support comprising an absorbent material entrapped in a non-woven fiber matrix, wherein the support comprises a first and a second major surface and wherein the absorbent material is present in no more than 50% by weight of the support;
a release coating layer on at least the first major surface of the support.

2. The article of claim 1, further comprising a first adhesive layer contacting the release coating layer, wherein the first adhesive layer comprises a pressure sensitive adhesive.

3. The article of claim 2, wherein the release coating layer comprises a silicone.

4. The article of claim 1, wherein the absorbent material is a porous material.

5. The article of claim 1, wherein the absorbent material comprises at least one of an activated carbon, a silica gel, a zeolite, and mixtures thereof.

6. The article of claim 1, wherein the non-woven fiber matrix comprises fibers, wherein the fibers comprises at least one of a natural fiber, a synthetic polymer fiber, and mixtures thereof.

7. The article of claim 6, wherein the synthetic polymer fiber comprises at least one of polyethylene, polypropylene, polyester, nylon, polylactic acid, and combinations thereof.

8. The article of claim 6, wherein the natural fiber comprises at least one of cellulose, hemp, bamboo, cotton, and mixtures thereof.

9. The article of claim 1, further comprising a first pressure sensitive adhesive, wherein the first pressure sensitive adhesive is disposed on the release coating layer.

10. The article of claim 1, wherein the article is a tape.

11. A method of making an adhesive article having low volatiles comprising:
(a) providing a support comprising an absorbent material entrapped in a non-woven fiber matrix and wherein the absorbent material is present in no more than 50% by weight of the support;
(b) disposing a release coating layer onto the support to form a liner; and
(c) disposing a pressure sensitive adhesive layer onto the liner such that the pressure sensitive adhesive layer is in contact with the release coating layer.

12. The article of claim 9, wherein the first pressure sensitive adhesive comprises at least one an acrylic, a tackified acrylic, a tackified rubber-based adhesive, silicone, polyurthanes, and combinations thereof.

13. The article of claim 1, further comprising a second release coating layer on the second major surface of the support.

14. The article of claim 9, further comprising a second pressure sensitive adhesive disposed on the second major surface of the support.

15. The adhesive article of claim 14, wherein the second pressure sensitive adhesive is different from the first pressure sensitive adhesive.

16. The adhesive article of claim 14, wherein the second pressure sensitive adhesive is the same as the first pressure sensitive adhesive.

17. The article of claim 1, wherein the article is a tape.

18. The article according to claim 1, wherein the article has a VOC of less than 1500 μg/g as measured by VOC Test Method.

19. The article according to claim 1, wherein the article has a FOG of less than 200 μg/g as measured by VOC Test Method.
